(19) United States
(12) Patent Application Publication
(10) Pub. No.: US 2025/0034410 A1
(43) Pub. Date: Jan. 30, 2025

(54) WATERBORNE ALUMINUM FORMULATION AND METHOD OF PREPARING THE SAME

(71) Applicant: PPG Coatings (Tianjin) Co., Ltd., Tianjin (CN)

(72) Inventors: Zhaozhe Zhang, Tianjin (CN); Wei Wei, Tianjin (CN); Liming Song, Tianjin (CN)

(73) Assignee: PPG Coatings (Tianjin) Co., Ltd., Tianjin (CN)

(21) Appl. No.: 18/713,567

(22) PCT Filed: Nov. 24, 2022
(86) PCT No.: PCT/CN2022/134039

§ 371 Date: May 24, 2024

(30) Foreign Application Priority Data
Nov. 25, 2021 (CN) 202111415104.5

(51) Int. Cl. C09D 7/61; C08F 220/06; C08F 220/14; C08K 3/08; C09D 7/45; C09D 133/02; C09D 133/06

(52) U.S. Cl. CPC C09D 7/61; C08F 220/06; C08F 220/14; C08K 3/08; C09D 7/45; C09D 133/02; C09D 133/066; C08F 2800/20; C08K 2003/0812

(57) ABSTRACT

Disclosed is a waterborne aluminum formulation, comprising aluminum powder, a passivation agent, and an acrylic resin. The invention also discloses a method of preparing a waterborne aluminum formulation comprising: (1) with high-speed stirring, adding a passivation agent, optionally an organic solvent, and optionally other additives, followed by adding aluminum powder to form a first premix: (2) sequentially adding an acrylic resin and water, followed by adding optionally other additives to form a second premix; and (3) with high-speed stirring, adding the second premix into the first premix. The invention further discloses a coating composition comprising the above waterborne aluminum formulation or the waterborne aluminum formulation prepared by the above method.

### TECHNICAL FIELD

The present invention relates to a waterborne aluminum formulation, and a coating composition comprising the waterborne aluminum formulation.

### BACKGROUND

Recently, by the influence of continuous upgrading environmental protection policies, countries in the world have started to formulate and implement various laws and regulations on environmental protection for all walks of life that cause environmental pollution and destruction. With the releases of new environmental protection regulations, the limitation for the VOCs (volatile organic compounds) in the coating become more and more strict. Even though waterborne coatings have numerous advantages over solvent based coatings, the VOC content thereof is still strictly limited. At present, the aluminum powder widely used in automobile coatings are still ordinary aluminum powder. The ordinary aluminum powder reacts with water in aqueous environment, which seriously affect the property of coatings, and thus it is necessary to passivate the aluminum powder. However, such process requires a large amount of solvent that hinders the reduction of total VOC in the coating formula. Although there are high-quality, surface-modified aluminum powder in the market, such as, coated aluminum powder, they are expensive. Also, the surface-modified aluminum powder has altered refractive index so that the metal effect thereof is affected.

From the perspective of the cost of large-scale production of coatings, the cost of management and control, and the requirements of modular production process, it is imperative to make the aluminum formulation to semi-finished products with storage stability. In addition, as a semi-finished product that should be stored for a long term, the gas evolution will be an important control point.

Therefore, to address the above problems, there is practical need to develop a waterborne aluminum formulation with a low VOC content, a low gas evolution, and storage stability, which has great commercial potential and economic benefits.

### BRIEF SUMMARY OF THE INVENTION

The present inventor has made a lot of studies and developed a waterborne aluminum formulation that has a low VOC content, a low gas evolution and superior storage stability, and satisfies the requirements of appearance (such as metallic effect) and mechanical property of finished coatings when applied in a waterborne coating system.

The present invention provides a waterborne aluminum formulation comprising aluminum powder, a passivation agent, and an acrylic resin.

The present invention further provides a method of preparing a waterborne aluminum formulation comprising:
(1) with high-speed stirring, adding a passivation agent, optionally an organic solvent, and optionally other additives, followed by adding aluminum powder to form a first premix;
(2) sequentially adding an acrylic resin and water, followed by adding optionally other additives to form a second premix; and
(3) with high-speed stirring, adding the second premix into the first premix.

The present invention further provides a coating composition comprising the waterborne aluminum formulation as described above or a waterborne aluminum formulation prepared by the method as described above.

The characteristics and advantages of the present invention will be particularly presented in the detailed description of the following embodiments.

### DETAILED DESCRIPTION OF THE INVENTION

As used herein, unless expressly stated otherwise, it should be understood that the numbers used in the description and claims, such as, those representing values, ranges, contents, or percentages, can be varied in all substances by the term “about”, even if this term is not clearly specified. Thus, unless indicated to the contrary, the numerical parameters listed in the description and claims herein are all approximations, and can be varied depending upon the properties to be obtained by the present invention.

Although the numerical ranges and parameters listing the broad scope of the present invention are approximations, the numerical records listed in the particular examples should be reported as precisely as possible. However, any numerical value inherently has a certain error. The error is an inevitable consequence of standard deviation found in its corresponding measurement method.

In addition, it should be understood that any numerical range described herein is intended to encompass all the sub-ranges subsumed therein. For example, a range of “1 to 10” is intended to include all the sub-ranges between (inclusive) the minimum value of 1 and the maximum value of 10, namely, it has a minimum value equal to or great than 1 and a maximum value equal to or less than 10.

In the present application, unless expressly stated otherwise, the use of singular includes plural and the use of plural includes singular. Moreover, in the present application, unless expressly stated otherwise, the use of “or” means “and/or”, even though “and/or” can be expressly used in some cases. In addition, in the present application, unless expressly stated otherwise, the use of “a” or “an” means “at least a/an”. For example, “a” polymer, “a” coating, or the like refers to one or more of any of these items. Also, as those skilled in the art will recognize, feature(s) of one embodiment can be used together with other embodiments, even if it is not explicitly stated.

As used herein, the term “waterborne” means that the solvent of the formulation (or the coating composition) comprises at least at least 50 wt % of water.

As used herein, the term “aluminum formulation” refers to an aluminum powder-containing mixture that is used as component for preparing a coating composition, and can be directly added into the coating composition in use to provide metal effect. The term “directly added” means that no additional pre-processing treatment is required prior to addition into the coating.

The waterborne aluminum formulation according to the present invention is not curable. The term “not curable” means that after a formulation is baked at 140° C. for 30 min, the formed film layer has a MEK double wiping value of less than 50 times, suitably even less than 10 times.

The waterborne aluminum formulation according to the present invention has a low VOC content. As used herein, the term “VOC (volatile organic compound)” refers to any organic compound that has a boiling point of less than or equal to 250° C. (482° F.) as measured under standard atmospheric pressure of 101.3 kPa. Organic solvents are the main source of VOCs. The VOC content (without water) of the waterborne aluminum formulation according to the present invention can be at most about 550 g/L. The VOC value can be obtained by measuring the contents of various organic compound components in the formulation using gas chromatography, and summing up the contents of various components.

The waterborne aluminum formulation according to the present invention has a low gas evolution. The term “gas evolution” refers to the gas amount produced by the reaction of aluminum with solvent, e.g., water. Thus, the gas evolution can serve as an index reflecting the effect of surface passivation of aluminum powder. Herein, the gas evolution is measured by a gas expansion test as described below.

The waterborne aluminum formulation according to the present invention has storage stability. The term “storage stability” means that a formulation remains its properties unchanged after standing at room temperature for a time period, that is, the formulation is stable in terms of pH, fineness, viscosity, and appearance (without layer separation, flocculation, precipitation, crusting, caking, or the like issues) Moreover, a coating composition prepared by the waterborne aluminum formulation stored at room temperature exhibits superior appearance and mechanical properties. As used herein, the term “room temperature” refers to 15° C. to 30° C. The waterborne aluminum formulation according to the present invention can have storage stability of more than 6 months.

The waterborne aluminum formulation according to the present invention has a high aluminum content. The term “aluminum content” refers to a percentage of aluminum powder based on the total weight of the waterborne aluminum powder formulation. The waterborne aluminum formulation according to the present invention has an aluminum content of greater than about 6 wt %, such as, an aluminum content of at least about 8 wt %, suitably an aluminum content of 8-16 wt %.

The waterborne aluminum formulation according to the present invention has a high solid content. The term “solid content” refers to a ratio of the residual mass of the formulation after evaporation to the total mass of the formulation. The waterborne aluminum formulation according to the present invention has a solid content of at least at least 22 wt %, suitably a solid content of about 22-28 wt %.

The waterborne aluminum formulation according to the present invention has a high fineness. The term “fineness” represents a degree to which the aluminum powder is finely dispersed within the formulation. The waterborne aluminum formulation according to the present invention has a Hegman fineness of 7.0 or more. The fineness is measured using scraper fineness meter, and expressed in Hegman. The measurement method can be evenly scraping the test sample on a fineness plate with a pointed scraper, and reading the value when spots with obvious continuous particles appear on the scraper, that is the fineness value.

The waterborne aluminum formulation according to the present invention can be used to prepare a coating composition, especially a waterborne coating composition. The waterborne coating comprising the waterborne aluminum formulation of the present invention 30) has superior appearance (such as, metal effect) and mechanical properties. The waterborne coating composition can be suitable for coating an automobile substrate, such as, a substrate for automobile body. The waterborne coating composition can be suitable for coating a metal substrate. As used herein, the term “coating” can refer to coating on a substrate without any coating layers, or coating on a substrate with one or more layers of coating.

The coating composition comprising the waterborne aluminum formulation of the present application can have an aluminum content of no more than 6 wt %. The aluminum content refers to a percentage of the aluminum powder based on the total weight of the coating composition. The coating composition comprising the waterborne aluminum formulation of the present application can have a solid content of less than 22 wt %, suitably a solid content of 18-22 wt %. The solid content refers to a ratio of the residual mass of the coating composition after evaporation to the total mass of the coating composition.

The present invention provides a waterborne aluminum formulation comprising aluminum powder, a passivation agent, and an acrylic resin.

The aluminum powder used in the waterborne aluminum formulation according to the present invention can be ordinary aluminum powder. The term “ordinary aluminum powder” refers to aluminum powder without surface modification. The term “modification” comprises, but is not limited to, mechanochemical modification, surface chemical modification, oxidation modification, coating modification, plasma processing, etc. The aluminum powder used in the waterborne aluminum formulation according to the present invention can comprise aluminum powder with surface modification.

The aluminum powder used in the waterborne aluminum formulation according to the present invention can have any suitable dimension. For example, the aluminum powder used in the present invention can have a particle diameter of 5-30 μm. For example, the aluminum powder used in the present invention can have a diameter-to-thickness ratio of 5:1-10:1. The term “diameter-to-thickness ratio” refers to a ratio of the diameter to the thickness in aluminum powder. The term “particle diameter” and “thickness” are D50 size, that is, 50% of the particles have a dimension within the measured dimension range. The particle dimension can be measured by commercially available particle size analyzer.

In general, based on the total weight of the waterborne aluminum formulation, the waterborne aluminum formulation according to the present invention can comprise greater than about 6 wt %, suitably at least about 7 wt %, suitably at least about 8 wt %, and/or at most about 20 wt %, such as, at most about 16 wt %, suitably at most about 14 wt % of the aluminum powder. Based on the total weight of the waterborne aluminum formulation, the aluminum powder can be present in waterborne aluminum formulation in a range of about 6-20 wt %, suitably 7-16 wt %, such as, 8-14 wt %, or any other combinations of these end values.

The passivation agent used in the waterborne aluminum formulation according to the present invention comprises phosphate-modified passivation agents. The term “phosphate-modified passivation agent” refers to a compound that contains a phosphate group and can function to passivate the surface of the aluminum powder.

In general, based on the total weight of the waterborne aluminum formulation, the waterborne aluminum formulation according to the present invention can comprise at least about 3 wt %, suitably at least about 5 wt %, and/or at most about 10 wt %, suitably at most about 7 wt % of the phosphate-modified passivation agent. Based on the total weight of the waterborne aluminum formulation, the phosphate-modified passivation agent can be present in the waterborne aluminum formulation in a range of about 3-10 wt %, suitably 5-7 wt %, or any other combinations of these end values.

The acrylic resin used in the waterborne aluminum formulation according to the present invention refers to a homopolymer of acrylic or methacrylic monomers, or a copolymer of acrylic or methacrylic monomers with other system(s).

The acrylic resin used in the waterborne aluminum formulation according to the present invention can be prepared from a monomer mixture comprising 10-40 parts by weight of an acrylic monomer I, 50-80 parts by weight of an acrylic monomer II, and 2-10 parts by weight of a functional monomer. The acrylic monomer I can be one or more selected from the group consisting of ethyl acrylate, n-butyl acrylate, iso-butyl acrylate, and n-propyl acrylate. Suitably, the acrylic monomer I at least comprises n-butyl acrylate. The acrylic monomer II can be one or more selected from the group consisting of methacrylic acid, methyl methacrylate, ethyl methacrylate, and n-butyl methacrylate. Suitably, the acrylic monomer II at least comprises methacrylic acid, methyl methacrylate. The functional monomer can be one or more selected from the group consisting of hydroxypropyl acrylate, hydroxypropyl methacrylate, hydroxyethyl acrylate, hydroxyethyl methacrylate, and ethylene glycol dimethacrylate. Suitably, the functional monomer at least comprises hydroxyethyl acrylate, hydroxyethyl methacrylate, ethylene glycol dimethacrylate.

The acrylic monomer I, the acrylic monomer II and the functional monomer can comprise at least 90 wt % of the total weigh of the acrylic resin, e.g., at least 95 wt %, such as, at least 98 wt %, or even 100 wt %.

Suitable acrylic resin for use in the waterborne aluminum formulation of the present invention can have a hydroxyl value of 10-80 mg KOH/g, such as, a hydroxyl value of 20-60 mg KOH/g. The hydroxyl value refers to milligrams of potassium hydroxide (KOH) equivalent to the hydroxyl group in 1 gram of resin. Suitably, the acrylic resin can have an acid value of 5-40 mg KOH/g, such as, an acid value of 10-30 mg KOH/g. The “acid value” refers to milligrams of KOH required to neutralize the free acid in 1 gram of resin. Suitably, the acrylic resin can have a glass transition temperature of 0° C. to 80° C., such as, glass transition temperature of 20° C. to 50° C. The “glass transition temperature” can be measured by dynamic thermomechanical analyzer (DMA) using TA Instruments Q800 instrument with measurement parameters of: a frequency of 10 Hz, an amplitude of 5 mm, a temperature gradient of −100° C. to 250° C., and a Tg determined as the peak of tan δ curve according to ASTM D7028.

Suitable acrylic resin for use in the waterborne aluminum formulation of the present invention can be in an emulsion form with solid content of 25-30 wt %. The “solid content” refers to a percentage of the residual mass of a solution after evaporation in the original mass of the emulsion.

In general, based on the total weight of the waterborne aluminum formulation, the waterborne aluminum formulation according to the present invention can comprise at least about 2 wt %, suitably at least about 3 wt %, and/or at most about 8 wt %, suitably at most about 5 wt % of the acrylic resin. Based on the total weight of the waterborne aluminum formulation, the acrylic resin can be present in the waterborne aluminum formulation in a range of 2-8 wt %, suitably 3-5 wt %, or any other combinations of these end values.

Suitably, in the waterborne aluminum formulation according to the present invention, the weight ratio of the aluminum powder to the acrylic resin can be at least 2, suitably at least 3, such as, at least 3.5, at least 4, and/or at most 7, suitably at most 6, such as, at most 5.5, at most 5. Suitably, in the waterborne aluminum formulation according to the present invention, the weight ratio of the aluminum powder to the acrylic resin can be 2-7, e.g., 3-6, e.g., 3.5-5.5, suitably 4-5, or any other combinations of these end values.

The waterborne aluminum formulation according to the present invention can comprise an organic amine. Suitably, the organic amine for use in the present invention comprises dimethyl ethanol amine (DMEA). In general, based on the total weight of the waterborne aluminum formulation, the waterborne aluminum formulation according to the present invention can comprise about 0.1-2 wt % of the organic amine.

The waterborne aluminum formulation according to the present invention can comprise a surfactant. Suitably, the surfactant for use in the present invention comprises a multi-functional surfactant with wetting and defoaming properties. In general, based on the total weight of the waterborne aluminum formulation, the waterborne aluminum formulation according to the present invention can comprise about 2-10 wt % of the surfactant.

The waterborne aluminum formulation according to the present invention can comprise a substrate wetting agent. Suitably, the substrate wetting agent for use in the present invention comprises a silicon-free substrate wetting agent. Suitably, the substrate wetting agent comprises a silicon-free substrate wetting agent with low foaming tendency. In general, based on the total weight of the waterborne aluminum formulation, the waterborne aluminum formulation according to the present invention can comprise about 1-5 wt % of the substrate wetting agent.

The waterborne aluminum formulation according to the present invention can further comprise an organic solvent. The organic solvent comprises alcohol-, alcohol ether-, and/or aliphatic hydrocarbon-based organic solvent. Examples of suitable organic solvents comprise, but are not limited to, alcohols, such as, ethanol, butanol, isopropanol, etc.; alcohol ethers, such as, propylene glycol methyl ether, dipropylene glycol methyl ether, ethylene glycol butyl ether, propylene glycol butyl ether, etc.; and aliphatic hydrocarbons, such as, pentane, hexane, octane, etc. Based on the total weight of the waterborne aluminum formulation, the waterborne aluminum formulation according to the present invention can comprise about 5-10 wt % of the organic solvent.

The waterborne aluminum formulation according to the present invention can further comprise 30-70 wt % of water based on the total weight of the formulation.

The waterborne aluminum formulation according to the present invention can further comprise one or more of other additives (adjuvants) including but not limited to, dispersants that facilitate the compatibility of components in the formulation; foam suppressors and defoamers that suppress the foam formation and allow the generated foam to escape or break during the production; pH adjustors for controlling the pH and stabilizing the coating; thickeners that increase the viscosity and protect the formation from precipitation and layer separation; or the like. When present, each additive is present in an amount of at most about 2 wt % based on the total weight of the formulation.

The present invention further provides a method of preparing a waterborne aluminum formulation comprising:
(1) with high-speed stirring, adding a passivation agent, optionally an organic solvent, and optionally other additives, followed by adding aluminum powder to form a first premix;
(2) sequentially adding an acrylic resin and water, followed by adding optionally other additives to form a second premix; and
(3) with high-speed stirring, adding the second premix into the first premix.

The “high-speed stirring” as used herein, also known as “high-speed dispersing/dispersion”, refers to mixing and/or dispersing performed by commercially available high-speed stirrer or high-speed disperser. The high-speed stirring can adopt any suitable rotational speed. For example, the high-speed stirring can adopt a rotational speed of 600-1000 rpm.

In the method according to the present invention, the first premix obtained in the above step (1) can have a Hegman fineness of 5.5 or more after mixed with the organic solvent at a ratio of 1:1. The organic solvent comprises alcohol-, alcohol ether-, and/or aliphatic hydrocarbon-based organic solvent. Suitably, the time for the high-speed stirring in the above step (1) can be 15-30 min.

In the method according to the present invention, the second premix obtained in the above step (2) has a Hegman fineness of 7.5 or more. Suitably, the time for the high-speed stirring in the above step (2) can be 15-30 min.

In the method according to the present invention, the above step (3) further comprises adding additional water to adjust the viscosity to 50-90 mPa·s as measured at room temperature. The viscosity can be measured at room temperature and a shear rate of 1000 s⁻¹. Suitably, the time for the high-speed stirring in the above step (3) can be 15-30 min.

In the method according to the present invention, the other additives in the above step (1) can comprise an organic amine. In the method according to the present invention, the other additives in the above step (1) can comprise a surfactant. In the method according to the present invention, the other additives in the above step (1) can comprise a substrate wetting agent.

In the method according to the present invention, the other additives in the above step (2) can comprise an organic amine. In the method according to the present invention, the other additives in the above step (2) can comprise a thickener.

The waterborne aluminum formulation prepared in accordance with the above method can have a Hegman fineness of 7.0 or more.

Suitably, the method of preparing a waterborne aluminum formulation in accordance with the present invention comprises:
(1) with high-speed stirring, adding a passivation agent, an organic solvent, an organic amine, a surfactant, a substrate wetting agent, followed by adding aluminum powder, to form a first premix;
(2) with high-speed stirring, sequentially adding an acrylic resin, water, followed by adding an organic amine, a thickener, to form a second premix;
(3) with high-speed stirring, adding the second premix into the first premix, and adding additional water to adjust the viscosity to 50-90 mPa·s (at room temperature). The viscosity can be measured at room temperature and a shear rate of 1000 s⁻¹.

The present invention further provides a waterborne coating composition comprising the above waterborne aluminum formulation or a waterborne aluminum formulation prepared in accordance with the above method. The waterborne coating composition can further comprise a film-forming resin. Suitably, in the waterborne coating composition, the weight ratio of the aluminum powder to the film-forming resin can be not greater than 0.4, suitably not greater than 0.35, such as, not greater than 0.3.

The waterborne coating composition can be used to coat a substrate. The substrate comprises a metal substrate. The substrate is a part of vehicle, e.g., automobile body. The waterborne coating composition can be applied by any known standard method in the art, e.g., spray coating, dipping coating, roller coating, brush coating, etc., and then cured under heating and/or radiation conditions to form a coating.

### Examples

The following examples are provided to further illustrate the present invention, but should not be construed to limit the present invention to the details of the examples. All parts and percentages in the following examples are by weight, unless otherwise stated.

### Examples

The waterborne aluminum formulations Ex1 to Ex3 provided by the present invention were prepared using the components and amounts listed in Table 1 below. The particular steps comprise: (1) with high-speed stirring, adding the passivation agent, the organic solvent, the organic amine, the surfactant, the substrate wetting agent, followed by adding the aluminum powder, and stirring for 15-30 min, to form a first premix; (2) with high-speed stirring, sequentially adding the acrylic resin, water, followed by adding the organic amine, the thickener, and stirring 15-30 min, to form a second premix; (3) with high-speed stirring, adding the second premix into the first premix, followed by adding additional water to adjust the viscosity to 50-90 mPa·s (at room temperature and a shear rate of 1000 s⁻¹), and stirring for 15-30 min.

TABLE 1
The waterborne aluminum formulations Ex1
to Ex3 according to the present invention

| | | | |
|---|---|---|---|
| Components | Ex1 (wt %) | Ex2 (wt %) | Ex3 (wt %) |

First Premix

| | | | |
|---|---|---|---|
| Aluminum Powder ^{a} | 16.4 | 17.1 | 14.8 |
| Passivation Agent ^{b} | 11 | 10.9 | 11 |
| Organic Amine ^{c} | 0.3 | 0.3 | 0.3 |
| Additive ^{d} | 5.8 | 5.7 | 5.8 |
| Additive ^{e} | 2.9 | 2.9 | 2.9 |
| Organic Solvent ^{f} | 8.5 | 8.5 | 8.6 |

Second Premix

| | | | |
|---|---|---|---|
| Acrylic Resin ^{g} | 11.7 | 11.9 | 11.3 |
| Organic Amine ^{c} | 0.2 | 0.2 | 0.2 |
| Additive ^{h} | 1.4 | 1.4 | 1.4 |
| Deionized Water | 20.4 | 20.7 | 19.7 |
| Deionized Water | 21.4 | 20.4 | 24 |

^{a} Ordinary aluminum powder product with solid content of 55-80 wt %;
^{b} Phosphate-modified passivation agent with solid content of 45-70 wt %, available from PPG;
^{c} DEMA;
^{d} Multifunctional surfactant;
^{e} Silicon-free substrate wetting agent with low foaming tendency;
^{f} Alcohol ether-based organic solvent;
^{g} Acrylic resin emulsion with solid content of 20-35 wt %, wherein the acrylic solid is prepared from a monomer mixture comprising: 10-40 parts by weight of an acrylic monomer I, 50-80 parts by weight of an acrylic monomer II, 2-10 parts by weight of a functional monomer, wherein the acrylic monomer I comprises n-butyl acrylate; the acrylic monomer II comprises methacrylic acid, methyl methacrylate; and the functional monomer comprises hydroxyethyl acrylate, hydroxyethyl methacrylate, ethylene glycol dimethacrylate;
^{h} Thickener: BYK AQUATIX 8421.

### Comparative Example

The aluminum formulation CE1 was prepared using the components and amounts listed in Table 2 below. The particular steps comprise: with high-speed stirring, adding the organic solvent, the amino resin, the organic amine, the passivation agent, followed by adding the aluminum powder, and stirring for 15-30 min.

TABLE 2
The aluminum formulation CE1 of Comparative Example

| Components | CE1 (wt %) |
|---|---|
| Aluminum Powder ^{a} | 24.3 |
| Passivation Agent ^{b} | 8.4 |
| Organic Amine ^{c} | 0.6 |
| Amino Resin ^{d} | 24.3 |
| Organic Solvent ^{f} | 42.4 |

^{a} Ordinary aluminum powder product with solid content of 55-80 wt %;
^{b} Phosphate-modified passivation agents with solid content of 45-70 wt %, available from PPG;
^{c} DEMA;
^{d} Etherified amino resin;
^{f} Alcohol ether-based organic solvent.

### Tests for Performance:

The waterborne aluminum formulations Ex1 to Ex3 provided by the present invention and the Comparative Example CE1 were subject to various test as below:

### 1—Gas Evolution:

The waterborne aluminum formulations Ex1 to Ex3 stood at room temperature for 24 hours, and then 250 g of each formulation was placed into a gas evolution device. The device containing the test sample Ex1 to Ex3 was placed into a constant-temperature water bath at 40° C. for 2 hours, and then water for test was injected into the gas evolution device which was then sealed to start the test. After 7 days, the released water in the device (in the upper chamber) was removed and measured in a measuring cylinder. The resultant volume is considered as the gas evolution.

NOTE: 1) The water level in the water bath should be higher than the test sample; 2) in addition to the sealing of the gas evolution device, the water bath should be sealed to protect the water in the bath from volatilization.

| Gas Evolution | Ex1 | Ex2 | Ex3 |
|---|---|---|---|
| 40° C. * 7 Days | <10 mL | <10 mL | <10 mL |

### 2—VOC Content

Herein, the VOC (without water, g/L) contents of the waterborne aluminum formulations Ex1 to Ex3 according to the present invention and CE1 of Comparative Example were calculated based on the following method:

For 1 g of the formulation, the mass mi of each component in the formulation, the mass m_{w} of water in the formulation, and the density ρₛ of the composition were measured, respectively.

Calculation was conducted according to the following equation,

$${ρ ( VOC )}_{\text{?}} = [ \frac{{\sum }_{\text{?}}^{\text{?}} {m}_{\text{?}}}{1 - {ρ}_{\text{?}} \times \frac{{m}_{\text{?}}}{{ρ}_{\text{?}}}} ] \times {ρ}_{\text{?}} \times 1 \; 000$$

$$\text{?} \text{indicates text missing or illegible when filed}$$

wherein ρ_{w} is the density of water at 23° C.

| | Ex1 | Ex2 | Ex3 | CE1 |
|---|---|---|---|---|
| VOC | <550 | <550 | <550 | 670 |
| (free of water, g/L) | | | | |

### 3—Stability

The waterborne aluminum formulations Ex1 to Ex3 and CE1 of Comparative Example were tested and recorded for their initial pH, fineness, and viscosity; placed in a constant-40° C. explosion-proof box. The samples were removed every week and cooled to room temperature, tested and recorded for their pH, fineness, and viscosity, and observed for the occurrence of layer separation, flocculation, precipitation, crusting, caking, etc. It lasted for 1 month. The pH and viscosity were measured by commercially available pH meter and viscometer. The fineness was measured by scraper fineness meter, and expressed in microns.

For pH, fineness and viscosity, the change of each current data as compared with its corresponding initial data was calculated, that is, (the current data—the initial data)/the initial data. If the change is within 60%, the stability is considered as qualified; and if the change is greater than 60%, the stability is considered unqualified.

For the status, it is considered qualified if no layer separation, flocculation, precipitation, crusting, caking, or the like occurs.

| | Ex1 | Ex2 | Ex3 | CE1 |
|---|---|---|---|---|
| pH | Qualified | Qualified | Qualified | Unqualified |
| Fineness | Qualified | Qualified | Qualified | Unqualified |
| Viscosity | Qualified | Qualified | Qualified | Unqualified |
| Status | Qualified | Qualified | Qualified | Unqualified |

### 4—Tests for Other Performances

With respect to the use of the aluminum formulation in the coating, the waterborne aluminum formulations Ex1 to Ex3 and CE1 of Comparative Example were used in application and compared for their main properties.

The waterborne aluminum formulations Ex 1 to Ex3 that had been stored at room temperature for 1 month and CE1 of Comparative Example that was freshly prepared were added into the same PPG commercially available waterborne basecoat. Then, the resultant basecoat were subject to tests for Flip-flop Index, appearance, and mechanical properties.

The FI (Flip-flop Index) refers to the flip-flop effect of the coating. Herein, the brightness values at angles of 15, 45, and 110 degree were measured using a BYK-mac i multiple angle colorimeter, respectively, and calculation was conducted according to the following formula:

$$F I = 2.69 * {( L 15 - L 110 )}^{1.11} / {( L 45 )}^{0.86}$$

The appearance was observed for the presence of phenomena such as layer separation, flocculation, precipitation, crusting, caking, or the like.

| | Ex1 | Ex2 | Ex3 | CE1 |
|---|---|---|---|---|
| FI | = | = | = | = |
| Appearance | + | + | + | = |
| Properties (including chemical | = | = | = | = |
| resistance, scratch resistance, | | | | |
| aging resistance, adhesion, | | | | |
| moisture resistance, impact | | | | |
| resistance, hardness, | | | | |
| compatibility with adhesive, etc.) | | | | |

NOTE:
By reference to the results of various property tests of CE1, = indicates the same level, + indicates represents a level higher than the reference level, i.e., better.

It can be seen from the results of the above property tests that the waterborne aluminum formulation provided by the present invention has a low VOC and gas evolution, and superior storage stability. After 1 month of storage, the waterborne basecoat prepared from the waterborne aluminum formulation has superior flip-flop effect and appearance, and has a comparable mechanical properties with a coating prepared with a freshly prepared aluminum paste.

Although the particular aspects of the present invention have been illustrated and described, it is obvious to persons skilled in the art that many other variations and modifications can be made without departing the spirit and scope of the present invention. Thus, the accompanying claims are intended to encompass all of these variations and modifications falling within the scope of the present invention.

1. A waterborne aluminum formulation, comprising an aluminum powder, a passivation agent, and an acrylic resin.

2. The waterborne aluminum formulation of claim 1, wherein the formulation is not curable.

3. The waterborne aluminum formulation of claim 1, wherein the formulation has a solid content of ≥22 wt %.

4. The waterborne aluminum formulation of claim 1, wherein a weight ratio of the aluminum powder to the acrylic resin is of ≥2.

5. The waterborne aluminum formulation of claim 1, wherein the formulation has an aluminum content of >6 wt % based on the total weight of the formulation.

6. The waterborne aluminum formulation of claim 1, wherein the formulation has an aluminum content of 8-16 wt % based on the total weight of the formulation.

7. The waterborne aluminum formulation of claim 1, wherein the acrylic resin is prepared from a monomer mixture comprising 10-40 parts by weight of an acrylic monomer I, 50-80 parts by weight of an acrylic monomer II, and 2-10 parts by weight of a functional monomer, wherein the acrylic monomer I is one or more selected from ethyl acrylate, n-butyl acrylate, isobutyl acrylate, and n-propyl acrylate; the acrylic monomer II is one or more selected from methacrylic acid, methyl methacrylate, ethyl methacrylate, and n-butyl methacrylate; and the functional monomer is one or more selected from hydroxypropyl acrylate, hydroxypropyl methacrylate, hydroxyethyl acrylate, hydroxyethyl methacrylate, and ethylene glycol dimethacrylate.

8. The waterborne aluminum formulation of claim 7, wherein the acrylic monomer I comprises at least at least n-butyl acrylate, the acrylic monomer II comprises at least methacrylic acid, methyl methacrylate, and the functional monomer comprises at least hydroxyethyl acrylate, hydroxyethyl methacrylate, and ethylene glycol dimethacrylate.

9. The waterborne aluminum formulation of claim 1, wherein the acrylic resin has a hydroxyl value of 10-80 mg KOH/g, an acid value of 5-40 mg KOH/g, and a glass transition temperature of 0-80° C.

10. The waterborne aluminum formulation of claim 1, wherein the passivation agent comprises a phosphate modified passivation agent.

11. The waterborne aluminum formulation of claim 1, wherein the aluminum powder comprises aluminum powder without surface modification.

12. The waterborne aluminum formulation of claim 1, further comprises a surfactant.

13. The waterborne aluminum formulation of claim 1, further comprising a silicon-free substrate wetting agent.

14. The waterborne aluminum formulation of claim 1, wherein the aluminum formulation has a VOC of at most 550 g/L as measured without water.

15. The waterborne aluminum formulation of claim 1, wherein the formulation has a Hegman fineness of 7.0 or more.

16. A method of preparing a waterborne aluminum formulation comprising:
(1) with high-speed stirring, adding a passivation agent, optionally an organic solvent, and optionally other additives, followed by adding aluminum powder to form a first premix;
(2) sequentially adding an acrylic resin and water, followed by adding optionally other additives to form a second premix; and
(3) with high-speed stirring, adding the second premix into the first premix.

17. (canceled)

18. (canceled)

19. The method of claim 16, further comprising adding water to adjust the viscosity to 50-90 mPa·s as measured at room temperature to (3).

20. The method of claim 16, wherein the waterborne aluminum formulation has a Hegman fineness of 7.0 or more.

21. A coating composition comprising the waterborne aluminum formulation of claim 1, or the waterborne aluminum formulation prepared by the method of claim 16.

22. The coating composition of claim 21, wherein the coating composition is waterborne.

23. The coating composition of claim 21, wherein the coating composition has an aluminum content of ≤6 wt % based on the total weight of the composition.

24. The coating composition of claim 21, wherein the composition is applied on an auto substrate.
